(19) United States
(12) Patent Application Publication
(10) Pub. No.: US 2025/0085596 A1
(43) Pub. Date: Mar. 13, 2025

(54) Display Panel

(71) Applicants: HUIZHOU CHINA STAR OPTOELECTRONICS DISPLAY CO., LTD., Huizhou, Guangdong (CN); TCL CHINA STAR OPTOELECTRONICS TECHNOLOGY CO., LTD., Shenzhen, Guangdong (CN)

(72) Inventor: Jinming LIU, Huizhou, Guangdong (CN)

(73) Assignees: HUIZHOU CHINA STAR OPTOELECTRONICS DISPLAY CO., LTD., Huizhou, Guangdong (CN); TCL CHINA STAR OPTOELECTRONICS TECHNOLOGY CO., LTD., Shenzhen, Guangdong (CN)

(21) Appl. No.: 18/569,225

(22) PCT Filed: Oct. 8, 2023
(86) PCT No.: PCT/CN2023/123328

§ 371 Date: Dec. 12, 2023

(30) Foreign Application Priority Data
Apr. 12, 2023 (CN) 202310426716.7

(51) Int. Cl. G02F 1/1362

(52) U.S. Cl. CPC G02F 1/136222; G02F 1/136286

(57) ABSTRACT

The embodiment of the present disclosure is directed to a display panel, which includes a first substrate, a color film layer, a transparent conductive layer, a protective layer and a pixel electrode layer. The transparent conductive layer is provided with a hollow area that exposes the color film layer. The protective layer is arranged on the transparent conductive layer and covers the hollow area. The pixel electrode layer is disposed on the protective layer. The present disclosure can improve the problem of high reflectivity.

### FIELD OF THE INVENTION

The present disclosure relates to the field of display technology, more particularly, to a display panel.

### BACKGROUND

With the continuous development of liquid crystal displays (LCD), the characteristics of wide viewing angle, low energy consumption, and high charging rate have become important performance indicators to measure the progressiveness of products. In the research and practice of existing technologies, the inventors of the present disclosure have found that in order to improve the pixel opening rate, a thin film electrode is directly added between the Polymer Film on Array (PFA) layer and the color film layer of the display panel to replace the Data BM Less (DBS) electrode setting in the existing technology. However, this setting method requires additional light to pass through the thin film electrode layer when passing through the display panel, resulting in an additional interface for light to pass through. Moreover, due to the significant difference in refractive index between the PFA layer and the color film layer, and the thin film electrode layer, the reflectivity increases, affecting the display effect. Therefore, it is indeed necessary to develop a display panel to overcome the shortcomings of existing technology.

### Technical Problem

One embodiment of the present disclosure is directed to a display panel that can improve the problem of high reflectivity in the display panel.

### Technical Solution

One embodiment of the present disclosure is directed to a display panel comprising:
a first substrate;
a color film layer, arranged on the first substrate;
a transparent conductive layer, arranged on the color film layer, and provided with a hollow area that exposes the color film layer;
a protective layer, arranged on the transparent conductive layer and covering the hollow area;
a pixel electrode layer is arranged on the protective layer.

Optionally, in some embodiment of the present disclosure, the pixel electrode layer comprises a plurality of spaced pixel electrodes, and the hollow area is opposite to at least one of the pixel electrodes.

Optionally, in some embodiment of the present disclosure, the transparent conductive layer comprises:
at least two first main electrodes, disposed with at least two first main electrodes spaced in a first direction;
a first edge electrode, extending in a second direction and connected to a first end of the first main electrode;
a second edge electrode, extending in the second direction and connected to a second end of the first main electrode;
a first branch electrode, connected to one of the first main electrodes and extends in a direction different from the first directions and the second direction;
wherein the hollow area is formed between an adjacent first main electrode, the first edge electrode, the second edge electrode, and the first branch electrode.

Optionally, in some embodiment of the present disclosure, the pixel electrode further comprises:
a border electrode, enclosed in an enclosed area;
a second main electrode, connected to the border electrode and located within the enclosed area;
a third main electrode, connected to the border electrode and intersecting with the second main electrode, wherein the second main electrode and the second main electrode divide the enclosed area into a plurality of sub regions;
a plurality of second branch electrodes, distributed in the sub regions, wherein each of the sub regions is connected to the second main electrode;
wherein the second branch electrode is misaligned with the first branch electrode within the sub regions.

Optionally, in some embodiment of the present disclosure, an overlap area of the transparent conductive layer on an orthographic projection of the first substrate and the pixel electrode layer on a orthographic projection of the first substrate is S1, and the pixel electrode layer on the orthographic projection of the first substrate is S2, S1/S2=½.

Optionally, in some embodiment of the present disclosure, a refractive index of the protective layer is D1, a refractive index of the transparent conductive layer is D2, |D1−D2|<0.37.

Optionally, in some embodiment of the present disclosure, a material of the protective layer is silicon oxide or silicon nitride, and a material of the transparent conductive layer is indium tin oxide or indium zinc oxide or tin zinc oxide.

Optionally, in some embodiment of the present disclosure, the display panel further comprises an insulation layer arranged between the color film layer and the transparent conductive layer. A refractive index of the color film layer is D3, and a refractive index of the insulation layer is D4, D3<D4<D2.

Optionally, in some embodiment of the present disclosure, the display panel further comprises a data line. The data line is arranged between the first substrate and the color film layer, and the transparent conductive layer is arranged opposite to the data line.

Optionally, in some embodiment of the present disclosure, the display panel further comprises a second substrate and a black matrix. The second substrate is arranged opposite to the first substrate and is located on a side of the pixel electrode layer away from the first substrate, and the black matrix is oriented towards a side of the second substrate towards the first substrate.

The black matrix is set opposite to the data line.

Optionally, in some embodiment of the present disclosure, an orthographic projection of the black matrix on the first substrate overlaps an orthographic projection of the data line on the first substrate.

### Advantageous Effect

The present disclosure sets up a hollow area between the transparent conductive layer and the protective layer, which exposes the color film layer. This way, when light passes through the display panel, some of the light can be directly incident onto the color film layer from the protective layer through the hollow area, reducing the reflection of light due to passing through the interface of the transparent conductive layer, thereby reducing reflectivity, improving the display effect, and improving image quality.

### BRIEF DESCRIPTION OF THE DRAWINGS

FIG. 1 is a schematic diagram of a structure of a display panel according to one embodiment of the present disclosure.

FIG. 2 is a schematic diagram of a local structure of a transparent conductive layer and a pixel electrode layer according to another embodiment of the present disclosure.

### DETAILED DESCRIPTION OF PREFERRED EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

In order to make the purpose, technical solutions and effects of the present disclosure clear and definite, the present disclosure will be further described in detail below with reference to the accompanying drawings and examples. It should be understood that the specific embodiments described here are only used to explain the present application and are not used to limit the present disclosure.

When adding a thin film electrode between the PFA layer and the color film layer on existing display panels, assuming that the wavelength of the incident light is 550, the refractive index of the PFA layer is N1=1.56, the refractive index of the thin film electrode is N2=1.93, and the refractive index of the color film layer is N3=1.49. Therefore, the reflectivity of the display panel is

$$R 1 = \frac{{( {N}_{1} - {N}_{2} )}^{2}}{{( {N}_{1} + {N}_{2} )}^{2}} + \frac{{( {N}_{2} - {N}_{3} )}^{2}}{{( {N}_{2} + {N}_{3} )}^{2}} ( 1 - \frac{{( {N}_{1} - {N}_{2} )}^{2}}{{( {N}_{1} + {N}_{2} )}^{2}} ) = 2.76 \% ,$$

resulting in a higher reflectivity of the display panel, Therefore, it is indeed necessary to develop a display panel to overcome the shortcomings of existing technology.

An embodiment of the present application provides a display panel as explained in detail below. It should be noted that the order of description of the following embodiments does not limit the preferred order of the embodiments.

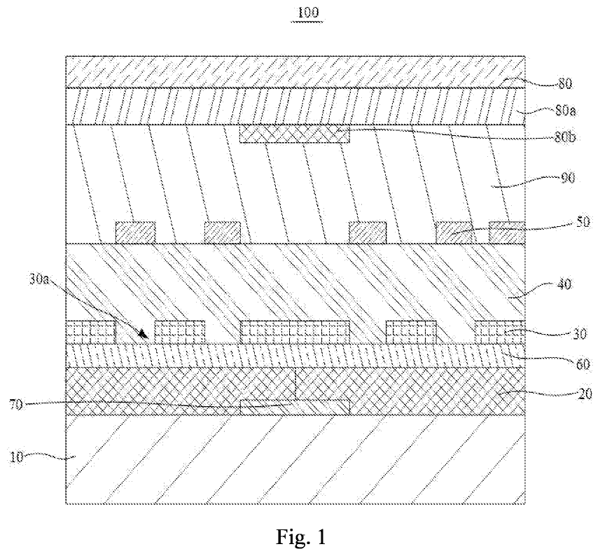

Please refer to FIG. 1. One embodiment of the present disclosure is directed to a display panel 100, which comprises a first substrate 10, a color film layer 20, a transparent conductive layer 30, a protective layer 40, and a pixel electrode layer 50.

The color film layer 20 is arranged on the first substrate 10. The transparent conductive layer 30 is arranged on the color film layer 20, and the transparent conductive layer 30 is provided with a hollow area 31 that exposes the color film layer 20. The protective layer 40 is placed on the transparent conductive layer 30 and covers the hollow area 31. The pixel electrode layer 50 is arranged on the protective layer 40.

It is noted that the first substrate 10 further comprises a thin film transistor, which is electrically connected to the transparent conductive layer 30 and the pixel electrode layer 50, respectively, to control the pixel electrode layer 50 and the transparent conductive layer 30. The transparent conductive layer 30 can not only be used to increase storage capacitance, but also to control the deflection of the liquid crystal layer 90 in a corresponding area. Each of the thin film transistors comprise a gate and a plurality of gate insulation layers, a plurality of active layers, a plurality of source and drain electrodes that are sequentially stacked. It can be understood that the present application does not limit the structure of the thin film transistor included in the thin film transistor layer. It can be either a top gate type thin film transistor or a bottom gate type thin film transistor, which can be a dual gate type thin film transistor or a single gate type thin film transistor. The specific structure of thin film transistors will not be elaborated in the present disclosure.

In addition, the color film layer 20 is usually formed using colored photoresist materials, which have filtering functions, high color saturation, and good light transmittance. The color film layer 20 comprises a plurality of colors of photoresist materials. For example, the color film layer 20 can include a red photoresist layer, a green photoresist layer, and a blue photoresist layer. It can also include a red photoresist layer, a green photoresist layer, a blue photoresist layer, and a yellow photoresist layer. It can even include a transparent photoresist layer, and a red photoresist layer. The specific color can be adjusted according to design requirements and is not limited here.

The present disclosure sets a hollow area 31 between the transparent conductive layer 30 located between the color film layer 20 and the protective layer 40, which exposes the color film layer 20. In this way, when the light passes through the display panel 100, some of the light can directly enter the color film layer 20 from the protective layer 40 through the hollow area 31, in order to reduce the reflection of light due to passing through the interface of the transparent conductive layer 30, thereby reducing reflectivity, improving the display effect, and improving image quality.

Optionally, a refractive index D1 of the protective layer 40, a refractive index D2 of the transparent conductive layer 30, |D1−D2|<0.37. Among them, by making the refractive index of the transparent conductive layer 30 similar to the refractive index of the protective layer 40, when light is incident from the transparent conductive layer 30 to the protective layer 40, this further reduces the reflection of light, reduces the reflectivity of the display panel 100, and improves the display effect and image quality.

Furthermore, a material of the protective layer 40 is silicon oxide or silicon nitride, and the material of the transparent conductive layer 30 is indium tin oxide or indium zinc oxide or tin zinc oxide. It can be understood that when the material of the protective layer 40 is PFA material, the refractive index of the transparent conductive layer 30 is much higher than that of the protective layer 40. In order to reduce the difference in refractive index between the transparent conductive layer 30 and the protective layer 40, based on the selection of indium tin oxide or indium zinc oxide or tin zinc oxide in the transparent conductive layer 30, passivation materials with high refractive index, such as silicon oxide or silicon nitride, can be selected to form the protective layer 40. When the wavelength of the incident light is 550 and passes through the display panel 100, the range of the refractive index D1 of the protective layer 40 is 1.56<D1<2.3, while the refractive index D2 of the transparent conductive layer 30 is 1.93 when the wavelength of the incident light is 550. It should be noted that the difference between the refractive index of the transparent conductive layer 30 and the refractive index of the protective layer 40 can also be reduced by reducing the refractive index of the transparent conductive layer 30, By reducing the oxygen concentration and temperature of the deposited film during the preparation of the transparent conductive layer 30, the refractive index of the prepared transparent conductive layer 30 can be reduced, thereby reducing the difference in refractive index with the transparent conductive layer 30.

Please refer to FIG. 1. Optionally, the display panel 100 also comprises an insulation layer 60, which is located between the color film layer 20 and the transparent conductive layer 30. The refractive index of the transparent conductive layer 30 is D2, a refractive index of the color film layer 20 is D3, and a refractive index of the insulation layer 60 is D4, D3<D4<D2. By setting an insulation layer 60 between the transparent conductive layer 30 and the color film layer 20, and the refractive index range of the insulation layer 60 is between the refractive index of the transparent conductive layer 30 and the refractive index of the color film layer 20, the amplitude of the refractive index difference between adjacent film layers is reduced during the passage of light, thereby reducing the reflectivity, improving the display effect, and improving image quality.

Furthermore, the material of the insulation layer 60 is silicon nitride, and the material of the transparent conductive layer 30 is indium tin oxide or indium zinc oxide or tin zinc oxide. It can be understood that the color film layer 20 is formed using a color photoresist material. When the wavelength of the incident light is 550, the refractive index D3 of the color film layer 20 is 1.49. The refractive index D2 of the transparent conductive layer 30 formed by using indium tin oxide or indium zinc oxide or tin zinc oxide is 1.93. By selecting an insulating layer 60 made of silicon nitride as the material and setting it between the transparent conductive layer 30 and the color film layer 20, the refractive index D4 of the insulating layer 60 is 1.7, which meets the requirements of D3<D4<D2, thereby reducing the amplitude of the refractive index difference between adjacent film layers and avoiding direct light from the transparent conductive layer 30 with a higher refractive index into the color film layer 20 with a lower refractive index. This reduces the reflected light, thereby reducing the reflectivity and improving the display effect, Improve image quality. Furthermore, an interlayer insulation layer can be additionally arranged between the transparent conductive layer 30 and the protective layer 40. The material of the interlayer insulation layer can be the same as that of the insulating layer 60. Then, the refractive index of the interlayer insulation layer can be adjusted by adjusting the oxygen concentration and temperature of the deposited film during the preparation of the interlayer insulation layer, In this way, the refractive index of the interlayer insulation layer is between the refractive index D1 of the protective layer 40 and the refractive index D2 of the transparent conductive layer 30. This can prevent light from directly passing through the transparent conductive layer 30 and the color film layer 20 with a large difference, reduce the amplitude of the refractive index difference between adjacent film layers, reduce reflected light, and thereby reduce the reflectivity, thereby improving the display effect and improving image quality.

Please refer to FIG. 1. Optionally, the display panel 100 also comprises a data line 70, which is arranged between the first substrate 10 and the color film layer 20, and the transparent conductive layer 30 is opposite to the data line 70. It can be understood that the data line 70 can be used to connect the thin film transistor of the first substrate 10 and the pixel electrode layer 50. In order to reduce the coupling capacitance of the data line 70 and cause crosstalk on the display panel 100, the transparent conductive layer 30 is set opposite to the data line 70, that is, the transparent conductive layer 30 covers the data line 70 to shield the data line 70, reduce the occurrence of crosstalk, and improve the stability of the display panel 100.

Furthermore, the display panel 100 also comprises a second substrate 80 and a black matrix 80b. The second substrate 80 is arranged opposite to the first substrate 10 and is located on the side of the pixel electrode layer 50 away from the first substrate 10, and the black matrix 80b is oriented towards the side of the first substrate 10. The black matrix 80b is set opposite to the data line 70. It can be understood that the display panel 100 also comprises a liquid crystal layer 90, which is located between the second substrate 80 and the first substrate 10, and there is also a common electrode 80a on the second substrate 80. The pixel electrode layer 50 and the common electrode 80a layer can control the deflection of the liquid crystal layer 90 in the corresponding area. By setting a black matrix 80b on the second substrate 80 opposite to the first substrate 10 and making the black matrix 80b opposite to the data line 70 for occlusion, the black matrix 80b absorbs the light that is reflected back on the data line 70, thereby reducing the reflection light of the display panel 100, thereby reducing reflectivity, improving display effect, and improving image quality.

Furthermore, the orthographic projection of the black matrix 80b on the first substrate 10 coincides with the orthographic projection of the data line 70 on the first substrate 10. This can not only block the light reflected by data line 70, but also avoid setting the black matrix 80b too large to affect the light penetration rate of display panel 100.

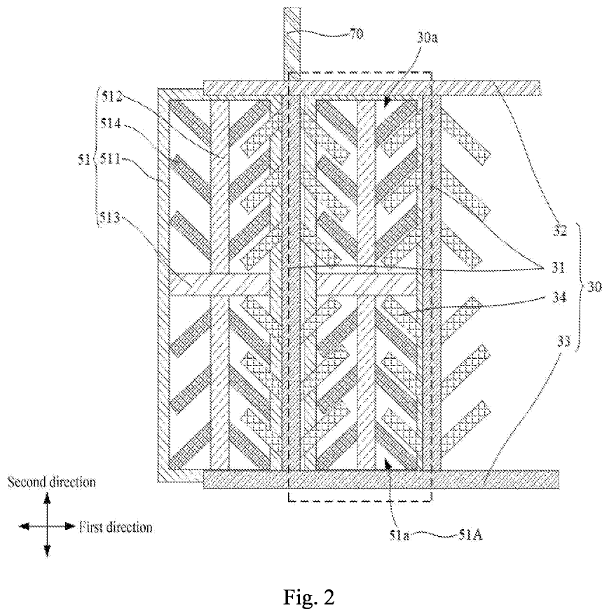

Please refer to FIG. 2. Optionally, the pixel electrode layer 50 comprises a plurality of spaced pixel electrodes 51, and the hollow area 30a is opposite to at least one of the pixel electrodes 51. Inside the dashed box is a pixel electrode 51, which can be set opposite to a pixel electrode 51 to allow some light to pass directly through the hollow area 30a after passing through the pixel electrode 51. This reduces the amount of light that passes through both the pixel electrode layer 50 and the transparent conductive layer 30, further reducing a plurality of reflections caused by entering different interfaces, thereby reducing reflectivity, improving display effect, and improving image quality. Of course, in order to further reduce reflectivity, the hollow area 30a can be increased to be set opposite to a plurality of pixel electrodes 51.

Furthermore, the transparent conductive layer 30 comprises at least two first main electrodes 31, a first edge electrode 32, a second edge electrode 33, and a first branch electrode 34, with at least two first main electrodes 31 spaced in the first direction. Extending in the second direction and connected to the first end of the first main electrode 31. Extending in the second direction and connected to the second end of the first main electrode 31. The first branch electrode 34 is connected to one of the first main electrodes 31 and extends in a direction different from the first and second directions. The hollow area 30a is formed between the adjacent first main electrode 31, the first edge electrode 32, the second edge electrode 33, and the first branch electrode 34.

The first and second directions are set vertically. The transparent conductive layer 30 can be patterned to form a first main electrode 31, a first edge electrode 32, a second edge electrode 33, and a first branch electrode 34. It should be noted that the number of first branch electrodes 34 can be a plurality of, so that a plurality of first branch electrodes 34 can be spaced on the first main electrode 31 to ensure the electric field effect provided by the transparent conductive layer 30. The number of first main electrodes 31 can be three, four, and five, arranged in intervals along the first direction, which not only ensures the electric field effect provided by the transparent conductive layer 30, but also forms more hollow areas 30a and is set opposite to a plurality of pixel electrodes 51 to reduce the reflectivity.

Optionally, the pixel electrode 51 includes a border electrode 511, a second main electrode 512, a third main electrode 513, and a plurality of second branch electrodes 514. The border electrode 511 forms an enclosed area 51A. The second main electrode 512 is connected to the border electrode 511 and located within the enclosed area 51A. The third main electrode 513 is connected to the border electrode 511 and intersects with the second main electrode 512. The second main electrode 512 and the second main electrode 512 divide the enclosed area 51A into a plurality of sub areas 51a. Distributed in the sub region 51a, each of the second branch electrodes 514 is connected to the second main electrode 512. Within the sub region 51a, the second branch electrode 514 is misaligned with the first branch electrode 34.

Optionally, the transparent conductive layer 30 can be patterned to form a border electrode 511, a second main electrode 512, a third main electrode 513, and a plurality of second branch electrodes 514. This not only ensures the electric field effect that pixel electrode 51 can provide, but also further reduces the light passing through pixel electrode layer 50 and transparent conductive layer 30 simultaneously by setting the second branch electrode 514 and first branch electrode 34 in the same sub region 51a in a staggered manner, further reducing the occurrence of a plurality of reflections of light due to entering different interfaces, thereby reducing reflectivity, improving display effect, and improving image quality.

The overlap area between the orthographic projection of the transparent conductive layer 30 on the first substrate 10 and the orthographic projection of the pixel electrode layer 50 on the first substrate 10 is S1, and the orthographic projection of the pixel electrode layer 50 on the first substrate 10 is S2, S1/S2=½. In this way, the staggered area ratio between the pixel electrode layer 50 and the transparent conductive layer 30 on the first substrate 10 is exactly ½. At this point, assuming that when the wavelength of the incident light is 550 and passes through the display panel 100, and the material of the protective layer 40 is PFA material, the refractive index D1 of the protective layer 40 is 1.56, the refractive index D2 of the transparent conductive layer 30 is 1.93, and the refractive index D3 of the color film layer 20 is 1.49, the refractive index R2 of the display panel 100 is as follows:

$$R 2 = \frac{\{ \frac{{( D 1 - D 2 )}^{2}}{{( D 1 + D 2 )}^{2}} + \frac{{( D 2 - D 3 )}^{2}}{{( D 2 + D 3 )}^{2}} ( 1 - \frac{{( D 1 - D 2 )}^{2}}{{( D 1 + D 2 )}^{2}} ) + \frac{{( D 2 - D 3 )}^{2}}{{( D 2 + D 3 )}^{2}} \}}{2} = 1.43 \% ,$$

which reduces the reflectivity of its display panel 100 compared to before, thereby improving the display effect and image quality.

It can be understood that for ordinary technical personnel in this field, equivalent substitutions or changes can be made based on the technical solution and invention concept of the present disclosure, and all these changes or substitutions should fall within the protection scope of the claims attached to the present disclosure.

What is claimed is:

1. A display panel, comprising:
a first substrate;
a color film layer, arranged on the first substrate;
a transparent conductive layer, arranged on the color film layer and provided with a hollow area exposing the color film layer;
a protective layer, arranged on the transparent conductive layer and covers the hollow area; and
a pixel electrode layer, arranged on the protective layer.

2. The display panel as claimed in claim 1, wherein the pixel electrode layer comprises a plurality of spaced pixel electrodes, and the hollow area is opposite to at least one of the pixel electrodes.

3. The display panel as claimed in claim 2, wherein the transparent conductive layer comprises:
at least two first main electrodes, disposed with at least two first main electrodes spaced in a first direction;
a first edge electrode, extending in a second direction and connected to a first end of the first main electrode;
a second edge electrode, extending in the second direction and connected to a second end of the first main electrode; and
a first branch electrode, connected to one of the first main electrodes and extends in a direction different from the first directions and the second direction;
wherein the hollow area is formed between an adjacent first main electrode, the first edge electrode, the second edge electrode, and the first branch electrode.

4. The display panel as claimed in claim 3, wherein the pixel electrode further comprises:
a border electrode, enclosed in an enclosed area;
a second main electrode, connected to the border electrode and located within the enclosed area;
a third main electrode, connected to the border electrode and intersecting with the second main electrode, wherein the second main electrode and the second main electrode divide the enclosed area into a plurality of sub regions; and
a plurality of second branch electrodes, distributed in the sub regions, wherein each of the sub regions is connected to the second main electrode;
wherein the second branch electrode is misaligned with the first branch electrode within the sub regions.

5. The display panel as claimed in claim 1, wherein an overlap area of the transparent conductive layer on a orthographic projection of the first substrate and the pixel electrode layer on a orthographic projection of the first substrate is S1, and the pixel electrode layer on the orthographic projection of the first substrate is S2, S1/S2=½.

6. The display panel as claimed in claim 1, wherein a refractive index of the protective layer is D1, a refractive index of the transparent conductive layer is D2, and |D1−D2|<0.37.

7. The display panel as claimed in claim 6, wherein a material of the protective layer is silicon oxide or silicon nitride, and a material of the transparent conductive layer is indium tin oxide or indium zinc oxide or tin zinc oxide.

8. The display panel as claimed in claim 6, further comprising an insulation layer arranged between the color film layer and the transparent conductive layer, wherein a refractive index of the color film layer is D3, and a refractive index of the insulation layer is D4, D3<D4<D2.

9. The display panel as claimed in claim 1, further comprising a data line, wherein the data line is arranged between the first substrate and the color film layer, and the transparent conductive layer is arranged opposite to the data line.

10. The display panel as claimed in claim 8, further comprising a second substrate and a black matrix, wherein the second substrate is arranged opposite to the first substrate and is located on a side of the pixel electrode layer away from the first substrate, and the black matrix is oriented towards a side of the second substrate towards the first substrate; the black matrix is set opposite to the data line.

11. A display panel, comprising:
a first substrate, comprising a thin film transistor thereon;
a color film layer, arranged on the first substrate;
a transparent conductive layer, arranged on the color film layer and provided with a hollow area exposing the color film layer;
a protective layer, arranged on the transparent conductive layer and covers the hollow area; and
a pixel electrode layer, arranged on the protective layer.

12. The display panel as claimed in claim 11, wherein the pixel electrode layer comprises a plurality of spaced pixel electrodes, and the hollow area is opposite to at least one of the pixel electrodes.

13. The display panel as claimed in claim 12, wherein the transparent conductive layer comprises:
at least two first main electrodes, disposed with at least two first main electrodes spaced in a first direction;
a first edge electrode, extending in a second direction and connected to a first end of the first main electrode;
a second edge electrode, extending in the second direction and connected to a second end of the first main electrode; and
a first branch electrode, connected to one of the first main electrodes and extends in a direction different from the first directions and the second direction;
wherein the hollow area is formed between an adjacent first main electrode, the first edge electrode, the second edge electrode, and the first branch electrode.

14. The display panel as claimed in claim 13, wherein the pixel electrode further comprises:
a border electrode, enclosed in an enclosed area;
a second main electrode, connected to the border electrode and located within the enclosed area;
a third main electrode, connected to the border electrode and intersecting with the second main electrode, wherein the second main electrode and the second main electrode divide the enclosed area into a plurality of sub regions; and
a plurality of second branch electrodes, distributed in the sub regions, wherein each of the sub regions is connected to the second main electrode;
wherein the second branch electrode is misaligned with the first branch electrode within the sub regions.

15. The display panel as claimed in claim 11, wherein an overlap area of the transparent conductive layer on a orthographic projection of the first substrate and the pixel electrode layer on a orthographic projection of the first substrate is S1, and the pixel electrode layer on the orthographic projection of the first substrate is S2, S1/S2=½.

16. The display panel as claimed in claim 11, wherein a refractive index of the protective layer is D1, a refractive index of the transparent conductive layer is D2, and |D1−D2|<0.37.

17. The display panel as claimed in claim 16, wherein a material of the protective layer is silicon oxide or silicon nitride, and a material of the transparent conductive layer is indium tin oxide or indium zinc oxide or tin zinc oxide.

18. The display panel as claimed in claim 16, further comprising an insulation layer arranged between the color film layer and the transparent conductive layer, wherein a refractive index of the color film layer is D3, and a refractive index of the insulation layer is D4, D3<D4<D2.

19. The display panel as claimed in claim 11, further comprising a data line, wherein the data line is arranged between the first substrate and the color film layer, and the transparent conductive layer is arranged opposite to the data line.

20. The display panel as claimed in claim 18, further comprising a second substrate and a black matrix, wherein the second substrate is arranged opposite to the first substrate and is located on a side of the pixel electrode layer away from the first substrate, and the black matrix is oriented towards a side of the second substrate towards the first substrate; the black matrix is set opposite to the data line.
